(19) United States
(12) Patent Application Publication
(10) Pub. No.: US 2024/0411662 A1
(43) Pub. Date: Dec. 12, 2024

(54) ENHANCING NEXT ITEM RECOMMENDATION THROUGH CROSS-ATTENTION

(71) Applicant: Home Depot Product Authority, LLC, Atlanta, GA (US)

(72) Inventors: Walid Shalaby, Los Gatos, CA (US); Xiquan Cui, Brookhaven, GA (US); Janani Balaji, Atlanta, GA (US); Md Mehrab Tanjim, Atlanta, GA (US)

(21) Appl. No.: 18/736,371

(22) Filed: Jun. 6, 2024

Related U.S. Application Data
(60) Provisional application No. 63/471,692, filed on Jun. 7, 2023.

(51) Int. Cl. G06F 11/34; G06Q 30/0601; H04L 67/50

(52) U.S. Cl. CPC G06F 11/3438; G06Q 30/0631; H04L 67/535

(57) ABSTRACT

A system and method for predicting items for next item recommendation based on a sequence of user actions. The method may include receiving a sequence of user actions for a user, generating a respective embeddings vector representative of each of the user actions, determining respective pairwise similarities among the embeddings vectors, generating a respective attention embeddings vector for each of the user actions according to the similarities, applying a predictive model to the attention embeddings vectors to determine a predicted next user action, and outputting the predicted next user action to the user in response to receiving the sequence. The sequence of user actions can be a first sequence of user actions based on a first parameter and a second sequence of user actions based on a second parameter. The method may include training a machine learning model and deploying the trained model to make the predictions.

### CROSS-REFERENCE TO RELATED APPLICATIONS

The present application claims priority to and benefit of U.S. Provisional Patent Application No. 63/471,692, filed Jun. 7, 2023, and entitled “Enhancing Next Item Recommendation Through Cross-Attention,” the entirety of which is herein incorporated by reference.

### FIELD

The present disclosure generally relates to enhancing item predictions to be provided as recommendations to a particular user given the user's previous session information, including a particular training approach for a machine learning model for enhancing next item recommendations.

### BACKGROUND

Predictions of website user behavior may be utilized in numerous ways. For example, a user's browsing sequence may be used to predict, and therefore recommend, a user's next item selection based on the user's previous interactions with a website or application.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a diagrammatic view of a non-limiting example of a system, according to some embodiments.

FIG. 2 is a graphical diagram illustrating a non-limiting example of a target item prediction performed by the sequential recommendation system of the system, according to some embodiments.

FIG. 3 is a flow chart illustrating an example method of providing a next item recommendation to a user based on a sequence of actions of the user.

FIG. 4 is a flow chart illustrating another example method of providing a next item recommendation to a user based on a sequence of actions of the user.

FIG. 5 is a flow chart illustrating an example method of predicting a next item in a session, according to some embodiments.

FIG. 6 is a diagrammatic view of an example embodiment of a computing system environment, according to some embodiments.

### DETAILED DESCRIPTION

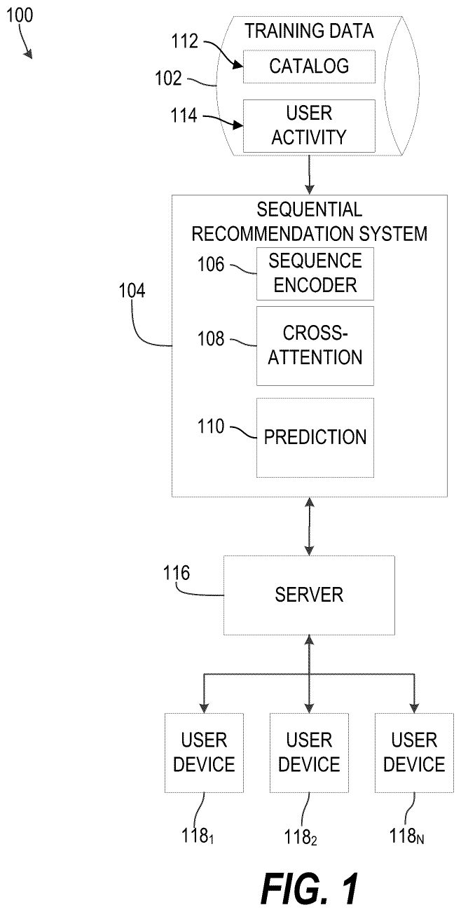

Referring to the drawings, wherein like numerals refer to the same or similar features in the various views, FIG. 1 illustrates a diagrammatic view of a non-limiting example of a system 100, according to some embodiments. The system 100 is for providing a recommendation to a user in a current session based on user activity information. The system 100 may include a training data source 102 and a sequential recommendation system 104 that may include one or more functional modules 106, 108, 110 embodied in hardware and/or software. In an embodiment, the functional modules 106, 108, 110 of the sequential recommendation system 104 may be embodied in a processor and a memory (i.e., a non-transitory, computer-readable medium) storing instructions thereon that, when executed by the processor, cause the system 100 to perform the functionality of the one or more of the functional modules 106, 108, 110 and/or other functionality in accordance with the present disclosure.

The training data source 102 includes a catalog dataset 112 and a user activity dataset 114. In some embodiments, the catalog dataset 112 may include data corresponding to items offered by an online merchant. In some embodiments, the catalog dataset 112 may also include information corresponding to the items. For example, in some embodiments, the catalog dataset 112 may include item specifications, dimensions, categories, classes, classifications, text data, other data, or any combinations thereof. The catalog dataset 112 may include a plurality of documents, each corresponding to a particular item, in some embodiments.

The training data source 102 includes the user activity dataset 114 corresponding to a session data between users and an entity. In some embodiments, the session data includes user activity for a website or application. In some embodiments, the user activity dataset 114 may include metadata of a user's behavior on a website or application. In some embodiments, the user activity dataset 114 includes current session information for a user(s). In some embodiments, the user activity dataset 114 may include previous session information for the user(s). For example, the user activity dataset 114 may include data corresponding to completed online transactions from previous sessions between a particular user and the online merchant. In some embodiments, the user activity dataset 114 may include data from a single session that may or may not have previous session information. In other embodiments, the user activity dataset 114 may include dual session data that includes current session information and previous session information. In some embodiments, the dual session data may include data corresponding to an immediate previous session from within a certain time period. For example, the dual session data may include previous session data from within the past week of a current session.

In some embodiments, the user activity dataset 114 may be accessible through a particular electronic user interface, such as a website or mobile application. In some embodiments, the user activity dataset 114 may be accessible through an application programming interface (“API”). In some embodiments, the user activity dataset 114 may include user activity on an electronic user interface, such as user navigation through the electronic user interface, sequence of user selection of items, completed transactions, other like data, or any combinations thereof.

The sequential recommendation system 104 and the associated functional modules 106, 108, 110 predict a next item (e.g., target item) for recommendation to a user based on the current session and based on the user's previous session, where the sequential recommendation system 104 determines a sequence of interacted items based on each session. To perform the next item recommendation, the sequential recommendation system 104 employs the functional modules 106, 108, 110 to encode the sequences to enable the sequential recommendation system 104 to perform a next item or target item prediction based on the user's sessions.

The functional modules 106, 108, 110 of the sequential recommendation system 104 may include a sequence encoder module 106. The sequence encoder module 106 may transform a user sequence of interacted items from the sessions, e.g., previous session, current session, or both, into a fixed-length sequence of steps, where the fixed-length sequence represents a maximum number of steps that the model may handle. If the sequence length exceeds the fixed-length, the sequence encoder module 106 may consider the most recent actions within the fixed-length, in some embodiments. If the sequence length is less than the fixed-length or there is no previous session data, the sequence encoder module 106 may apply a padding to the sequence until the sequence length reaches the fixed-length. In some embodiments, the sequence encoder module 106 may apply the padding to the sequence using a constant zero vector.

The sequence encoder module 106 may, for each step in the fixed-length sequence, concatenate the attributes (e.g., metadata) into a single embedding for the purposes of cross-attention, in some embodiments. In other embodiments, for each step in the fixed-length sequence, the sequence encoder module 106 may map the attributes of the interacted item of the step to a vector embedding. Therefore, for each step in the sequence, the respective item and its attributes may be mapped to real-valued vectors for the purposes of applying cross-attention. The sequence encoder module 106 may then concatenate these vector embeddings to form a single encoding for each respective item, in some embodiments. As such, in some embodiments, the concatenation of the vector embeddings may be based on the number of attributes and the dimensionality of the embeddings.

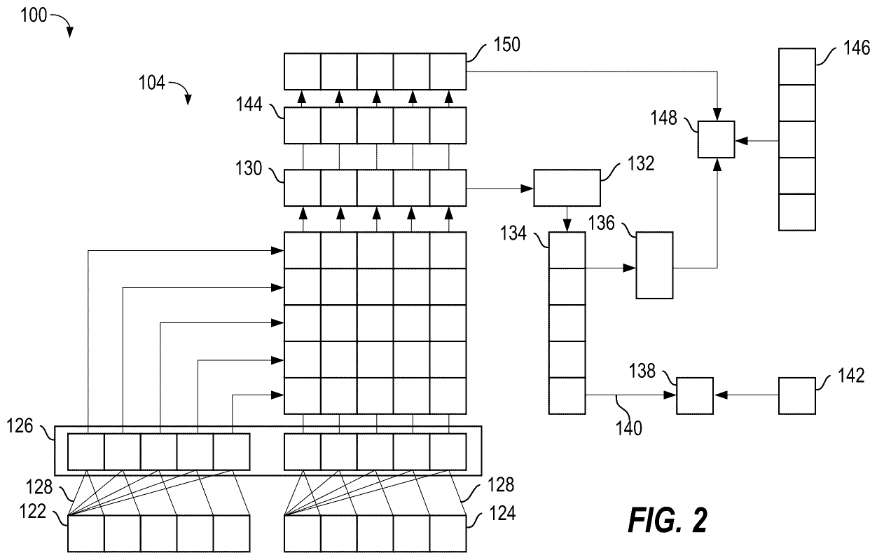

The functional modules 106, 108, 110 of the sequential recommendation system 104 may include a cross-attention module 108. The cross-attention module 108 may probe the information from the previous session(s) and from the current session to determine which information from the previous session is relevant to the current session and provide a final attention layer as output, as will be further described herein. As such, the cross-attention module 108 may determine a final attention layer having a final attention sequence 130, as shown in FIG. 2, as output, the final attention layer thereby having final attention scores corresponding to the relevancy between the previous and current sessions.

The functional modules 106, 108, 110 of the sequential recommendation system 104 may include a prediction module 110. The prediction module 110 performs a prediction of the next target item based on the final attention layer generated as output by the cross-attention module 108. In this regard, the prediction module 110 improves the model performance by generating a predicted target item embedding that is as similar as possible to the target item, as will be further described herein.

The sequential recommendation system 104 may be configured to train one or more machine learning models (e.g., one or more models included in sequence encoder module 106, cross-attention module 108, and/or prediction module 110) using the training data source 102. For example, in some embodiments, the sequential recommendation system 104 may include a training module for training a machine learning model using the data from the training data source 102 to enable the model to recognize and predict sequences of user actions based on metadata and user activity dataset 114 associated with those user actions. In some embodiments, the sequential recommendation system 104 may train the machine learning model using the catalog dataset 112 associated with items associated with the user actions.

The sequential recommendation system 104 may further be configured to use the trained machine learning model(s) to, given an input of a sequence of user actions from a previous session and current session, predict a next item corresponding to a most likely next user action (or multiple such actions). For example, the trained machine learning model may be applied in conjunction with a website to recommend a next item to a user based on that user's sequence of actions on the website. In some embodiments, the trained machine learning model may receive data corresponding to a sequence of documents, products and/or services that a user interacts with, such as by viewing, adding to cart, or purchasing, and may output to the user a predicted document corresponding to a product or service, or the characteristics of a predicted product or service, based on that sequence.

The system 100 may further include a server 116 in electronic communication with the sequential recommendation system 104 and with a plurality of user computing devices 1181, 1182, . . . 118N. The server 116 may provide a website, data for a mobile application, or other interface through which the users of the user computing devices 118 may navigate and otherwise interact with the items. For example, the server 116 may provide the documents of the catalog dataset 112 as respective pages or interface portions in the interface. In some embodiments, the server 116 may receive a sequence of user actions through the interface, provide the sequence of user actions to the sequential recommendation system 104, receive a next item prediction from the sequential recommendation system 104, and provide the next item prediction to the user (e.g., through the interface).

Further detail regarding the sequential recommendation system 104 and example knowledge graphs are shown in Appendix A, which is hereby incorporated by reference in its entirety.

FIG. 2 is a graphical diagram illustrating a non-limiting example of a target item prediction performed by the sequential recommendation system 104 of the system 100, according to some embodiments.

A model applied by the sequential recommendation system 104 may include an encoding layer which encodes the fixed-length sequences corresponding to the previous session 122 and current session 124 through self-attention and generates an attention layer sequence 126 having embeddings from both the previous session 122 and the current session 124. In this regard, applying self-attention to the attention layer sequence 126 determines a positional embedding for the current item embedding at each step or position of the individual sequence, thereby resulting in the attention layer sequence 126 having corresponding input embeddings. In some embodiments, the positional embeddings may be a dimensional vector having information about its position. In some embodiments, the current item embeddings may also be a dimensional vector having information about its position. In some embodiments, the attention layer sequence 126 is determined by applying a self-attention function to both the previous session 122 and current session 124. In some embodiments, the cross-attention module 108 may apply the self-attention function to the previous session 122 and the current session 124. In some embodiments, the self-attention function may be applied to each session individually. In other embodiments, the self-attention function may be applied to each previous session 122 from the training data source 102.

Determining the attention layer sequence 126 based on relevant items between the previous session 122 and the current session 124, such as by applying the self-attention function, improves the model performance for predicting next items compared to traditional approaches, which simply attaches the previous session information to the current session and encodes the entire sequence, e.g., previous and current session. However, traditional models fail to differentiate between information from the previous and current sessions and gives equal attention to the entire sequence rather than considering each session independently.

The sequential recommendation system 104 may apply a causal mask 128 when encoding the sequences of the previous session 122 and current session 124 to determine the attention layer sequence 126. The causal mask 128 maintains causality and prevents information flow from future to past by modifying attention. The causal mask 128 thereby prevents connections between a query value at a first position and a key value at a second position, where the first position and second position are two positions in one of the respective sequences and where the first position is lower than the second position in the sequence. Stated another way, the causal mask 128 modifies the attention by preventing a later item to impact an earlier item in the sequence. In this regard, the causal mask 128 enables the sequential recommendation system 104 to predict subsequent items in the sequence other than the first item. Moreover, although causality may not be strictly necessary when predicting a single target item that is not part of the sequence, the causal mask 128 improves model performance as compared to traditional model approaches for next item recommendation, which applies attention to each position from every other position in the sequence and thereby allows future items to influence past items.

Additionally, self-attention may also be applied to the embeddings of the attention layer sequence 126 by the sequential recommendation system 104 to compute similarity scores between item embeddings at different positions such that the sequential recommendation system 104 can determine relevancy between the previous session 122 and the current session 124. In this regard, the sequential recommendation system 104 may use self-attention to probe for relevant shared parameters between the previous session 122 and the current session 124 and to determine a final attention sequence 130 at a final attention layer as output. In some embodiments, the similarity of input embeddings at different positions in the attention layer sequence 126 is determined by applying by applying a self-attention function to the input embeddings. For example, the similarity of the input embeddings at the attention layer sequence 126, which is indicative of similarities between the previous session 122 and the current session 124, may be calculated based on applying a session encoding matrix for cross-attention purposes.

In some embodiments, the similarity of input embeddings at different positions of the attention layer sequence 126 may be determined by applying a scaled dot-product self-attention function to the attention layer sequence 126. Additionally, in some embodiments, the result may be further improved through residual connection and layer normalization, which enhances low-level information and stabilizes the training process for performing the next item prediction.

The final attention sequence 130 may be calculated by the sequential recommendation system 104 through a linear projection of the input embeddings, where the sequential recommendation system 104 uses the previous session outputs as keys and values and uses the current session outputs as queries. In some embodiments, the final attention scores of the final attention sequence 130 may be referred to as cross-attention scores.

The sequential recommendation system 104 may calculate averages 132 of the parameters of the final attention sequence 130 to summarize the context of the sessions at the final attention layer. In this regard, the sequential recommendation system 104 may summarize the context of the session by calculating the average 232 of the parameters of the final attention sequence 130 at the final attention layer. In some embodiments, the summarization of the context of the session by calculating the averages 132 is determined by applying an average pooling function to the parameters of the final attention sequence 130 at the final attention layer. Based on calculating the averages 132 of the parameters, target item prediction heads are determined by the sequential recommendation system 104 as outputs, which enables the sequential recommendation system 104 to determine a predicted target item embedding 136 for performing a target item prediction. In some embodiments, the prediction module 110 calculates the average 232 of the parameters and determines the embedding 136 for performing the target item prediction.

The sequential recommendation system 104 may determine the target item prediction and predicted target item attributes based on the average pooling of the final attention sequence 130. Accordingly, the sequential recommendation system 104 may output a fully connected layer including a target item prediction head 134 for making a target item prediction having a predicted target item embedding 136. Moreover, the sequential recommendation system 104 follows the target item prediction head 134 by determining a probability distribution over the candidates.

Additionally, the sequential recommendation system 104 may determine a loss 138 for the target item prediction head 134 using a cross-entropy loss. In some embodiments, the loss 138 for the target item prediction head 134 is calculated by comparing a prediction metadata 140 to a target metadata 142, such as obtained from the training data source 102 as shown in FIG. 1. Additionally, the sequential recommendation system 104 may determine one or more candidate embeddings 146 to enable calculating a loss for the target item prediction head 134, in some embodiments. In some embodiments, the candidate embeddings 146 may be determined from randomly sampled items out of the total items and extracting their corresponding embeddings. In some embodiments, the candidate embeddings 146 may be determined from the predicted target item embedding 136. In other embodiments, the candidate embeddings 146 may be determined from the randomly sampled items and the predicted target item embedding 136 and their corresponding embeddings. As such, the sequential recommendation system 104 outputs the predicted target item embedding 136 and the candidate embeddings 146 and may calculate cosine similarity scores between the predicted target item embedding 136 and candidate embeddings 146 to enable the sequential recommendation system 104 to make next item recommendations that are as similar as possible to the target item.

However, calculating a loss for the target item prediction head 134 penalizes all items except for the ground truth item, thereby penalizing similar items, in some embodiments. Accordingly, to minimize penalties for similar items at the target item prediction head 134 while enabling the sequential recommendation system 104 to generate a predicted target item embedding 136 that is as similar as possible to the target item, the sequential recommendation system 104 may, based on determining one or more candidate embeddings 146, calculate a probability distribution by calculating logits from dot product of candidate embeddings 146 and the predicted target item embedding 136 and k negative item embeddings and calculate possible outcomes (e.g., softmax scores), in some embodiments. Accordingly, this will reduce the penalty on similar positive items as the probability of sampling similar items is low if k is less than N, in some embodiments.

Accordingly, the sequential recommendation system 104 may calculate the similarity scores 148, e.g., loss scores, over the candidate embeddings 146, which maximizes the score for the predicted target item embedding 136 and minimizes the chance of drawings similar items by the sequential recommendation system 104 and thereby improving model performance. In some embodiments, the loss function may be a point-wise function. In other embodiments, the loss function may be a pairwise sigmoid loss function. In a preferred embodiment, the loss function may be a sampled softmax loss function.

Traditional recommendation frameworks typically rely on item identification, e.g., item ID, for item embeddings. However, the traditional approach as known in the prior art which utilizes item IDs for item embeddings thereby limits the embedding matrix. In contrast, the system 100 and the sequential recommendation system 104 applies a sequential model that may account for the dynamic nature of a user's intent within a single session by dynamically adjusting the kernel based on the current item and generates item embeddings from the metadata. Thus, the system 100 avoids having prediction heads associated with each item in the entity's catalog such as, for example, in catalog dataset 112. This novel approach is therefore free from typical cold-start issues associated with other traditional recommendation models and provides a scalable model capable of handling millions of items and does not require limiting the number of items for performing the next item prediction. Furthermore, the system 100 and the sequential recommendation system 104 may be capable of making predictions of not only a next item, but any k number of items due to the autoregressive nature of the sequential model. Accordingly, the embodiments described herein in the present disclosure may also include generative capability for predicting next items. It is to be appreciated by those having ordinary skill in the art that the number of items that the system 100 may include in performing the next item prediction determination is not intended to be limiting and may therefore be scalable based on a catalog dataset 112 associated with the entity.

Additionally, in some embodiments, the sequential recommendation system 104 may perform a second auxiliary task of determining an autoregressive prediction head 144 where every subsequent item is predicted using the outputs of the final attention sequence 130. The autoregressive prediction head 144 produces the predicted subsequent item embeddings 150 as output. In some embodiments, the autoregressive prediction head 144 is determining by feeding the outputs of the final attention sequence 130 through a single feed-forward network (with shared parameters for all positions). This second auxiliary task enhances the model's sensitivity to sequential information in the data, thereby providing further improvements to the next item recommendation provided by the sequential recommendation system 104.

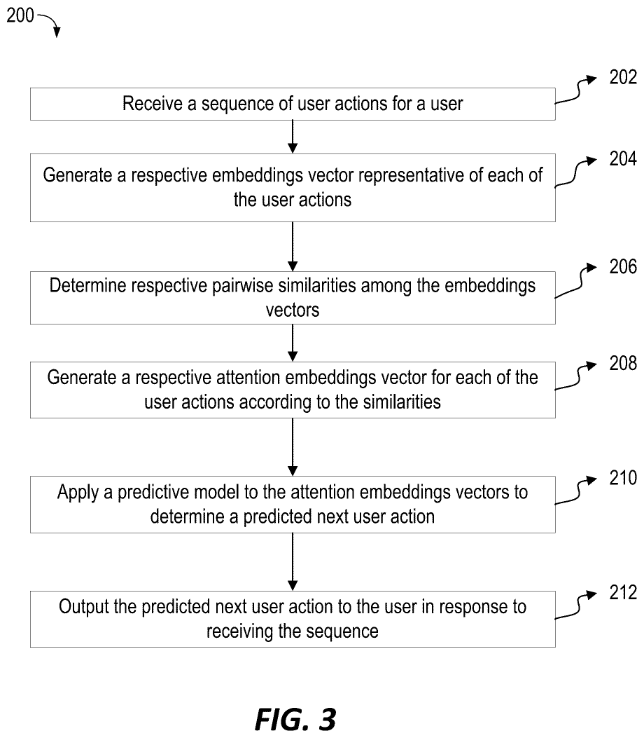

FIG. 3 is a flow chart illustrating an example method 200 of providing a next item recommendation to a user based on a sequence of actions of the user. The method 200, or one or more portions of the method 200, may be performed by the system 100, and more particularly by the sequential recommendation system 104, in some embodiments.

The method 200 may include, at 202, receiving a sequence of user actions for a user. The sequence of user actions can be received from an electronic user interface located at a computing device associated with the user. The sequence of user actions can be based on one or more user inputs at the electronic user interface. In some embodiments, the sequence of user actions includes one or more sequences of user actions based on a parameter. In some embodiments, receiving the sequence of user actions for the user includes receiving a first sequence of user actions based on a first parameter, and receiving a second sequence of user actions based on a second parameter. The sequence of user actions are shown at, for example, previous session 122 and current session 124 at FIG. 2.

The parameter can be any of a plurality of parameters determined based on user interactions with the computing network including, but not limited to, time intervals, category transitions, other parameters, or any combinations thereof. In some embodiments, the parameter can be a first parameter and a second parameter. For example, in some embodiments, the parameter can be a time interval. That is, the first parameter can be a first time period and the second parameter can be a second time period, the second time period occurring after the first time period.

The method 200 may include, at 204, generating a respective embeddings vector representative of each of the user actions. The embeddings vectors are determined based on the sequence of user actions. That is, the sequence of user actions can be received as data corresponding to the user actions.

In some embodiments, the data corresponding to the user actions may comprise metadata. In some embodiments, the embeddings vectors can be representative of metadata generated based on the user actions. The metadata can include, but is not limited to, user profile data, user data, user behavior data, user interaction data, current session data, previous session data, catalog data, clickstream data, device data, other types of data, or any combinations thereof. The embeddings vectors are shown at, for example, attention layer sequence 126 in FIG. 2.

The embeddings vectors can be generated by applying one or more algorithms to transform the data to determine the one or more embeddings vectors. In some embodiments, the data can be text data and the embeddings vectors can be determined based on transforming the text data into a sequence index.

In some embodiments, generating the respective embeddings vector representative of each of the user actions includes generating a first embeddings vector index based on the first sequence of user actions and generating a second embeddings vector index based on the second sequence of user actions. In some embodiments, the respective pairwise similarities are determined based on respective embeddings vectors from the first embeddings vector index and the second embeddings vector index. The first embeddings vector index and the second embeddings vector index is shown at, for example, attention layer sequence 126 in FIG. 2.

In some embodiments, generating the respective embeddings vector representative of each of the user actions includes applying a causal mask to the respective embeddings vector for each of the user actions. When encoding the sequence of user actions into the embeddings vectors, applying the causal mask enables maintaining causality and preventing information flow from future to past by modifying attention. The causal mask thereby prevents connections between keys and values of respective first embeddings vectors of a first embeddings vectors index representative of a first user sequence and the queries of respective second embeddings vectors of a second embeddings vectors index representative of a second user sequence. Stated another way, the causal mask modifies the attention by preventing a later user actions to impact an earlier user actions in the sequence of user actions. In this regard, the causal mask enables predicting subsequent items in the sequence other than the first item. Moreover, the causal mask does not apply attention to each position from every other position in the sequence and thereby limits future items from influencing past items. The causal mask is shown at, for example, causal mask 128 at FIG. 2.

The method 200 may include, at 206, determining respective pairwise similarities among the embeddings vectors. For each pair, an attention score may be determined based on the respective pairwise similarities. In some embodiments, the respective pairwise similarities may be determined by applying the embeddings vectors as input into a sequence matrix. The respective pairwise similarities are shown at, for example, the sequence matrix between attention layer sequence 126 and the final attention sequence 130 in FIG. 2.

In some embodiments, determining respective pairwise similarities among the embeddings vectors includes concatenating the respective embeddings vectors to determine the respective pairwise similarities among the embeddings vectors. The embeddings vectors can be input as respective keys and values and queries so as to determine the respective pairwise similarities among the embeddings vectors. In some embodiments, determining respective pairwise similarities among the embeddings vectors includes applying the first embeddings vector index as keys and values, applying the second embeddings vector index as queries, the attention embeddings vectors being generated based on the first embeddings vector index and the second embeddings vector index. In some embodiments, the first embeddings vector index can be applied as keys and values into the sequence matrix, the second embeddings vector index can be applied as queries into the sequence matrix, and the attention embeddings vectors being generated based on the first embeddings vector index and the second embeddings vector index input into the sequence matrix.

The method 200 may include, at 208, generating a respective attention embeddings vector for each of the user actions according to the similarities. The respective attention embeddings vector corresponding to a relevancy between the sequence of user actions. In some embodiments, the attention embeddings vectors can correspond to the relevancy between the first sequence of user actions based on the first parameter and the second sequence of user actions based on the first parameter. For example, the first parameter can be a previous session and the second parameter can be a current session. The attention embeddings vectors are shown at, for example, final attention sequence 130 in FIG. 2.

The method 200 may include, at 210, applying a predictive model to the attention embeddings vectors to determine a predicted next user action. The predicted next user action may be a next item for recommendation determined by the predictive model. In some embodiments, the predicted next user action may be one or more next items for recommendation determined by the predictive model. In some embodiments, the predicted next user action may be a next sequence of user actions determined by the predictive model. The predicted next user action may be determined, for example, based on predicted target item embedding 136 in FIG. 2.

In some embodiments, applying the predictive model to the attention embeddings vectors to determine the predicted next user action method further includes determining a respective target embeddings vector corresponding to a weighted average of the attention embeddings vectors. In some embodiments, the predicted next user action is determined based on target item embeddings vectors. The target embeddings vectors corresponding to the weighted average of the attention embeddings vectors are shown at, for example, target item prediction head 134 in FIG. 2.

In some embodiments, applying the predictive model to the attention embeddings vectors to determine the predicted next user action method further includes determining a plurality of predicted user actions based on the attention embeddings vectors, generating a respective candidate embeddings vector based on the plurality of predicted user actions, and determining a respective similarity between the candidate embeddings vectors and the target embeddings vectors. In some embodiments, the predicted next user action is determined based on the similarities between the target embeddings vectors and the candidate embeddings vectors.

The plurality of predicted user actions can include subsequent user actions that may be performed by the user. In some embodiments, the plurality of predicted user actions can include every subsequent user action that may be performed by the user. The plurality of predicted user actions can be determined by the predictive model using the attention embeddings vectors. In some embodiments, the plurality of predicted user actions can be determined by feeding the attention embeddings vectors through a single feed-forward network (with shared parameters for all positions). This second auxiliary task can then be utilized as an auto-regressive prediction head to enhance the model's sensitivity to sequential information in the data. The plurality of predicted user actions is shown at, for example, autoregressive prediction head 144 in FIG. 2.

The candidate embeddings vectors can be determined from the plurality of predicted user actions. In some embodiments, the candidate embeddings vectors can be randomly sampled embeddings vectors from the embeddings vectors associated with the plurality of predicted user actions. That is, the candidate embeddings vectors can be extracted from the embeddings vectors of the plurality of predicted user actions. The embeddings vectors associated with the plurality of predicted user actions are shown at, for example, predicted subsequent item embeddings 150 at FIG. 2. The candidate embeddings vectors is shown at, for example, candidate embeddings 146 in FIG. 2.

A respective similarity between the candidate embeddings vectors and the target embeddings vectors can be determined. The similarity score can be applied to the target embeddings vectors to enable the predictive model to make next user action recommendations that are as similar as possible to a target user action. In some embodiments, the similarity score can be a cosine similarity score. The similarity score can be determined, for example, at similarity scores 148 at FIG. 2.

In some embodiments, determining the respective similarity between the candidate embeddings vectors and the target embeddings vectors includes determining the respective similarity score between the target embeddings vectors and the candidate embeddings vectors based on applying a SoftMax loss function to the candidate embeddings vectors and the target embeddings vectors, and applying the respective similarity score to the respective target embeddings vector to enable the predictive model to make next user action recommendations that are as similar as possible to a target user action.

The method 200 may include, at 210, outputting the predicted next user action to the user in response to receiving the sequence. In some embodiments, the predicted next user action is determined based on the respective similarity score between the target embeddings vectors and the candidate embeddings vectors.

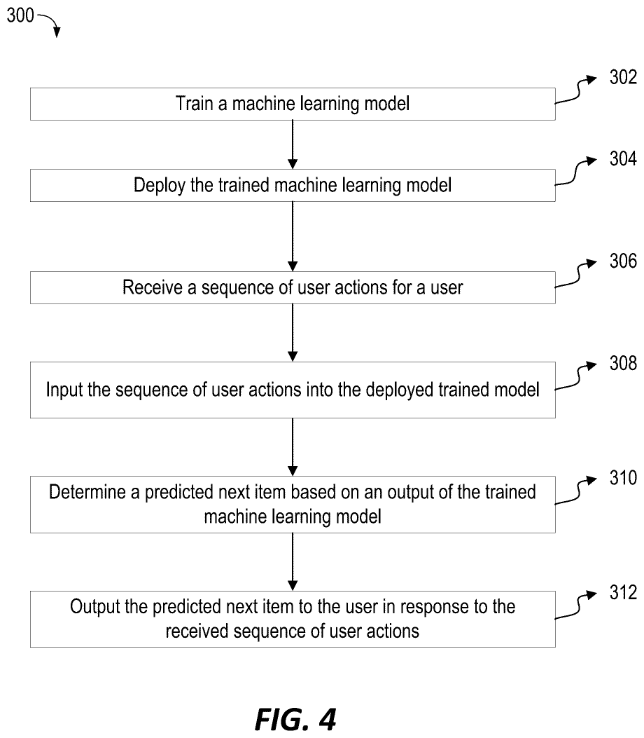

FIG. 4 is a flow diagram of a method 300, according to some embodiments. The method 300, or one or more portions of the method 300, may be performed by the system 100, and more particularly by the sequential recommendation system 104, in some embodiments.

The method 300 may include, at block 302, training a machine learning model. The machine learning model may be trained to receive, as input, a sequence of user actions from a previous session and a current session and to output one or more predicted next item recommendations. For example, in some embodiments, the machine learning model may be trained to accept a sequence of items selected by the user in a current session and a sequence of items purchased, viewed, and/or added to a purchase cart by the user in a previous session. In a further example, the machine learning model may be trained to accept data corresponding to a sequence of products and/or services available on an e-commerce website, such as documents corresponding to said products or services, and data corresponding to historical user co-browsing relationships between those products and/or services and to output a predicted next product or service or one or more characteristics of a predicted next product or service.

Training the machine learning model at block 302 may be performed using a set of training data that may include, for example, catalog data corresponding to items, e.g., products, or services accessible through a given interface, such as a website or mobile application. The training data may further include user activity through the interface, such as interaction with the items and/or their contents or subject, that occurred before training.

The method 300 may further include, at block 304, deploying the trained machine learning model. The trained machine learning model may be deployed in conjunction with a website or mobile application, such as the website or mobile application with which the training data is associated. After deployment, each user's sequence of actions on the interface may be analyzed according to the trained machine learning model, and output based on the trained machine learning model may be provided to the user through the interface.

The method 300 may further include, at block 302, receiving a sequence of user actions. The sequence of user actions may be a user's interactions with the interface with which the training data used at block 302 is associated. For example, the user actions may be a sequence of items that the user selects (e.g., clicks), navigates to, scrolls, or the contents (e.g., products and/or services) of which documents the user purchases, adds to cart, etc. within a given browsing session. In some embodiments, a weighting value may be associated with each item based on the user action and the items included in the session may be based on the item and the associated weighting. In some embodiments, the sequence of user actions may be a fixed-length sequence. Accordingly, the sequence of user actions included in a sequence may be limited to the fixed-length. In other embodiments, if the sequence of user actions is less than the fixed-length, the sequence may be padded to meet fixed-length. In some embodiments, the sequence of user actions may be from a current session, and the method 300 may further obtaining a sequence of user actions corresponding to a previous session.

The method 300 may further include, at block 304, inputting the sequence of user actions into the deployed trained model. The trained model receives sequences corresponding to a previous session and a current session. In some embodiments, for a current session, each new user action may be input to the trained model, such that the trained model is predicting a next user action in response to each new user action, based on the sequence of prior user actions from the previous session. In some embodiments, the fixed-length sequence corresponding to the current session is input to the deployed trained model and the fixed-length sequence may be iteratively updated with the new user action, such that the oldest user action is dropped off. In another example, the user actions within a single browsing session, or within a given time frame (e.g., one day), may be input to the model. In another example, up to a predetermined number of user actions (e.g., up to 50 user actions) without an intervening gap between actions that is greater than a threshold (e.g., a gap of one day or more between user actions may result in a new sequence of user actions) may be input to the model.

In response to the input sequence of user actions, the machine learning model may output one or more predicted next item(s), or one or more characteristics of the predicted next item(s) for purposes of predicting user's next actions. For example, the machine learning model may output one or more characteristics (e.g., a plurality of characteristics) of a predicted next item, such as one or more characteristics of a product or service that is the subject of the prediction. For example, in an embodiment in which the item is of a particular classification or category, the machine learning model may output words (e.g., unique attributes) that describe a predicted next product or service indicative of the classification or category associated with a predicted next item. In another embodiment, the machine learning model may output a unique identifier respective of one or more predicted next items.

The method 300 may further include, at block 310, determining a predicted next item based on an output of the trained machine learning model. For example, in an embodiment in which the model outputs a predicted target item as the predicted next user action, that item may be obtained from the catalog dataset 112. In some embodiments, the predicted target item provided as output from the model may be compared to the item embeddings from the current session, the previous session, or both to determine a similarity between the predicted next item and the sequence items. In another example, in an embodiment in which the machine learning model outputs characteristics of the item, or of a product or service, block 310 may include determining the item, product, or service on the interface that is most similar to the characteristics output by the model. In a further example, where the model outputs predicted target item embeddings, block 310 may include determining the item, product, or service having embeddings that are most similar to the embeddings output by the model.

The method 300 may further include, at block 312, outputting the predicted next item to the user in response to a received sequence of user events. For example, the predicted next item, or product or service that is the subject of the predicted next item, may be output to the user in the form of a page recommendation, product recommendation, service recommendation, etc., through the electronic interface. In some embodiments, block 312 may include displaying a link to the predicted next document in response to a user search. In some embodiments, block 312 may include displaying a link to the predicted next document in response to a user navigation. In some embodiments, block 312 may include displaying a link to the predicted next document in response to a user click.

In some embodiments, blocks 306, 308, 310, and 312 may be performed continuously respective of a plurality of users of an electronic interface to provide next item predictions to each of those users, responsive to each user's own activity. In some embodiments, predictions may be provided to a given user multiple times during the user's browsing or use session, such that the prediction is re-determined for multiple successive user actions in a sequence. For example, as new user actions replace older actions in the current user session, the model may perform the next item prediction as new user actions are received and the next item recommendation may be provided to the given user for each new user action.

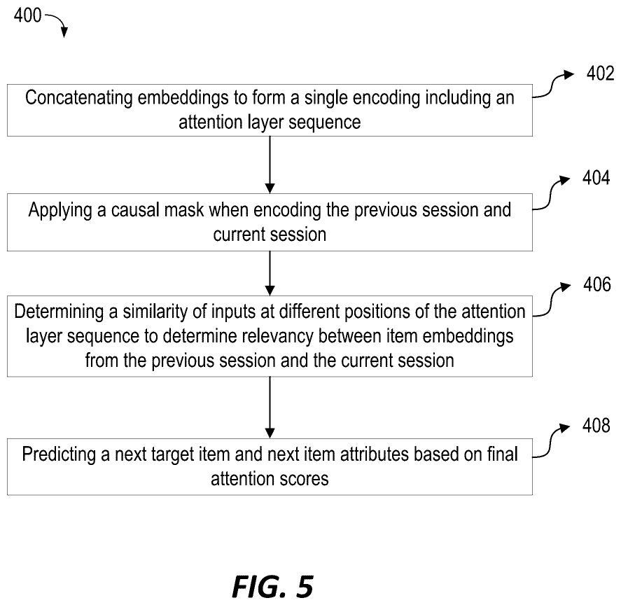

FIG. 5 is a flow chart illustrating an example method 400 of predicting a next item in a session, according to some embodiments. The method 400, or one or more portions of the method 400, may be performed by the sequential recommendation system 104 of FIG. 1.

The method 400 may include, at block 402, concatenating embeddings to form a single encoding comprising an attention layer sequence. For each item in the sequence, its item attributes, such as item-ID, category, title, etc., are mapped to real-valued vectors. In some embodiments, the block 402 may include attaching the previous session to the current session and encoding the entire sequence at the attention layer. In some embodiments, block 402 may include encoding the sequences associated with the sessions by associating a positional embedding to the current item embedding for each step or position, resulting in a sequence of input embeddings at an attention layer.

The method 400 may include, at block 404, applying a causal mask when encoding the previous session and current session. The causal mask maintains causality and prevents information flow from future items to past items by preventing connections between a query for a past item and a key for a future item, where the past item and future item are two items in the sequence.

The method 400 may include, at block 406, determining a similarity of inputs at different positions of the attention layer sequence to determine relevancy between item embeddings from the previous session and the current session. Similarities are identified between the previous session and the current session by calculating similarity scores between items at different positions at the attention layer. In some embodiments, block 406 may include determining final attention scores based on identifying the similarity between sessions. In some embodiments, block 406 may include applying self-attention to the sequence at the attention layer to calculate the similarity scores between items at different positions. In some embodiments, the final attention scores are determined by using the previous session outputs as keys and values, and the current session outputs as queries, and the final attention scores are thereby calculated between the previous and current sessions. In this regard, in some embodiments, block 404 may include outputting the final attention scores for the session at a final attention layer.

The method 400 may include, at block 408, predicting a next target item and next item attributes based on final attention scores. In some embodiments, block 408 may include summarizing the context of the session by average pooling the last attention layer, and determining a target item prediction head. In some embodiments, block 408 may further include determining candidate embeddings and calculating similarity scores between the output target item prediction head and candidate embeddings. In some embodiments, block 408 further includes generating a predicted target item embedding that is as similar as possible to the target item by calculating a loss between the candidate embeddings and the target item prediction head.

In some embodiments, the method 400 may further include determining an autoregressive prediction where every subsequent item in the sequence is predicted using the outputs of the final attention layer, which is fed through a single feed-forward network. In some embodiments, the single feed-forward network includes shared parameters for all positions. As such, for the next item recommendation, the target item embedding prediction head following the average pooling is used to predict the target item, in which the autoregressive prediction ensures the parameters from input to output prediction remain the same.

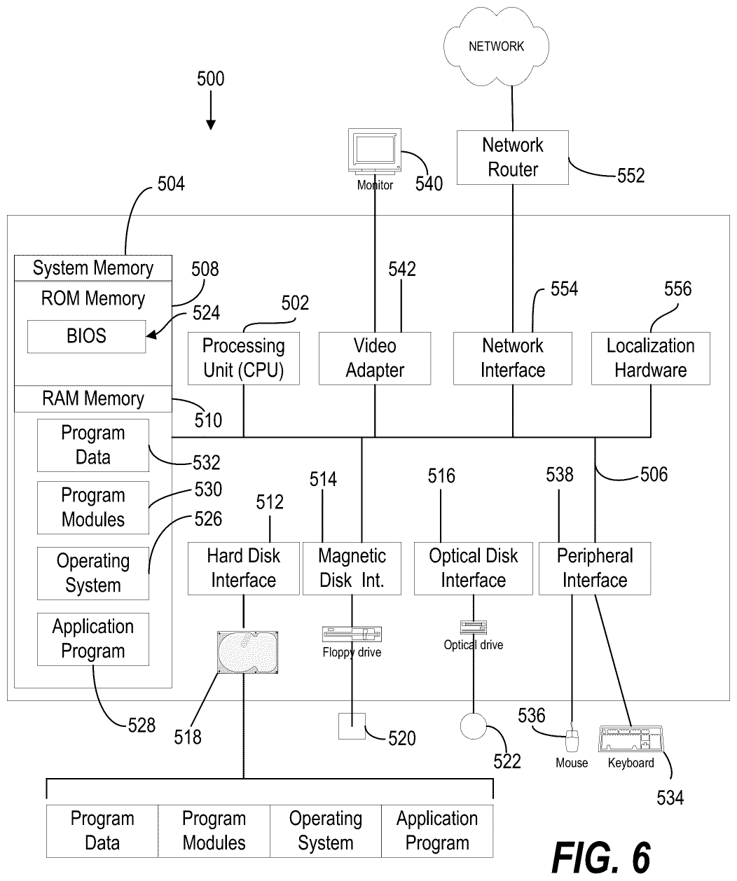

FIG. 6 is a diagrammatic view of an example embodiment of a computing system environment 500, according to some embodiments. The computing system environment 500 may be a general-purpose computing system environment, such as a desktop computer, laptop, smartphone, tablet, or any other such device having the ability to execute instructions, such as those stored within a non-transient, computer-readable medium. Furthermore, while described and illustrated in the context of a single computing system environment 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, the computing system environment 500 typically includes at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. The computing system environment 500 may have additional features and/or functionality. For example, the computing system environment 500 may also include additional storage (removable and/or non-removable) including, but not limited to, magnetic or optical disks, tape drives and/or flash drives. Such additional memory devices may be made accessible to the environment of computing system 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528 (which may include the functionality of the sequential recommendation system 104 of FIG. 1 or one or more of its functional modules 106, 108, 110 for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 552, that is responsible for network routing. Communications with the network router 552 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 556 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 100 of FIG. 1, in embodiments.

In some embodiments, a method for predicting a next user action at an electronic user interface includes receiving a sequence of user actions for a user, generating a respective embeddings vector representative of each of the user actions, determining respective pairwise similarities among the embeddings vectors, generating a respective attention embeddings vector for each of the user actions according to the similarities, applying a predictive model to the attention embeddings vectors to determine a predicted next user action, and outputting the predicted next user action to the user in response to receiving the sequence.

In some embodiments, receiving the sequence of user actions further includes receiving a first sequence of user actions based on a first parameter, and receiving a second sequence of user actions based on a second parameter.

In some embodiments, generating the respective embeddings vector representative of each of the user actions includes generating a first embeddings vector index based on the first sequence of user actions, and generating a second embeddings vector index based on the second sequence of user actions, the respective pairwise similarities being determined based on respective embeddings vectors from the first embeddings vector index and the second embeddings vector index.

In some embodiments, the method further including applying a causal mask to the respective embeddings vector for each of the user actions and concatenating the respective embeddings vectors to determine the respective pairwise similarities among the embeddings vectors.

In some embodiments, concatenating the respective embeddings vectors to determine the respective pairwise similarities among the embeddings vectors includes applying the first embeddings vector index as keys and values, and applying the second embeddings vector index as queries, the attention embeddings vectors being generated based on the first embeddings vector index and the second embeddings vector index.

In some embodiments, the method further including determining a respective target embeddings vector corresponding to a weighted average of the attention embeddings vectors, the predicted next user action is determined based on target item embeddings vectors.

In some embodiments, the method further including determining a plurality of predicted user actions based on the attention embeddings vectors, generating a respective candidate embeddings vector based on the plurality of predicted user actions, and determining a respective similarity between the candidate embeddings vectors and the target embeddings vectors, the predicted next user action being determined based on the similarities between the target embeddings vectors and the candidate embeddings vectors.

In some embodiments, determining the respective similarity between the candidate embeddings vectors and the target embeddings vectors including determining a respective similarity score between the target embeddings vectors and the candidate embeddings vectors based on applying a SoftMax loss function, and applying the respective similarity score to the respective target embeddings vector.

In some embodiments, the predicted next user action is determined based on the respective similarity score between the target embeddings vectors and the candidate embeddings vectors.

In some embodiments, the embeddings vectors are representative of metadata generated based on the user actions.

In some embodiments, a system including a processor, and a non-transitory computer readable media having stored therein instructions that are executable by the processor to perform operations including receive a first sequence of user actions based on a first parameter, receive a second sequence of user actions based on a second parameter, generate a respective embeddings vector representative of each of the user actions for the first sequence of user actions and the second sequence of user actions, determine respective pairwise similarities among the embeddings vectors, generate a respective attention embeddings vector for each of the user actions according to the similarities, apply a predictive model to the attention embeddings vectors to determine a predicted next user action, and output the predicted next user action to the user in response to receiving the sequence.

In some embodiments, generating the respective embeddings vector representative of each of the user actions includes generate a first embeddings vector index based on the first sequence of user actions, and generate a second embeddings vector index based on the second sequence of user actions, the respective pairwise similarities being determined based on respective embeddings vectors from the first embeddings vector index and the second embeddings vector index.

In some embodiments, the processor further performing operations including apply a causal mask to the respective embeddings vector for each of the user actions, apply the first embeddings vector index as keys and values, apply the second embeddings vector index as queries, and concatenate the first embeddings vector index and the second embeddings vector index to determine the respective pairwise similarities among the embeddings vectors, the attention embeddings vectors being generated based on the first embeddings vector index and the second embeddings vector index.

In some embodiments, the processor further performing operations including determine a respective target embeddings vector corresponding to a weighted average of the attention embeddings vectors, the predicted next user action being determined based on target item embeddings vectors.

In some embodiments, the processor further performing operations including determine a plurality of predicted user actions based on the attention embeddings vectors, generate a respective candidate embeddings vector based on the plurality of predicted user actions, determine a respective similarity score between the target embeddings vectors and the candidate embeddings vectors based on applying a SoftMax loss function, and apply the respective similarity score to the respective target embeddings vector, the predicted next user action being determined based on the respective similarity score between the target embeddings vectors and the candidate embeddings vectors.

In some embodiments, the embeddings vectors are representative of metadata generated based on the first sequence of user actions and the second sequence of user actions.

In some embodiments, a non-transitory computer readable media having stored therein instructions that are executable by a system to enable the system to perform operations including receive a first sequence of user actions based on a first parameter, generate a respective embeddings vector for a first embeddings vector index based on the first sequence of user actions, receive a second sequence of user actions based on a second parameter, generate a respective embeddings vector for a second embeddings vector index based on the second sequence of user actions, determine respective pairwise similarities among the embeddings vectors, the embeddings vectors being representative of metadata generated based on the user actions, generate a respective attention embeddings vector for each of the user actions according to the similarities, apply a predictive model to the attention embeddings vectors to determine a predicted next user action, and output the predicted next user action to the user in response to receiving the sequence, the respective pairwise similarities being determined based on respective embeddings vectors from the first embeddings vector index and the second embeddings vector index.

In some embodiments, the system further performing operations including apply a causal mask to the respective embeddings vector for each of the user actions, apply the first embeddings vector index as keys and values, apply the second embeddings vector index as queries, and concatenate the first embeddings vector index and the second embeddings vector index to determine the respective pairwise similarities among the embeddings vectors, the attention embeddings vectors being generated based on the first embeddings vector index and the second embeddings vector index.

In some embodiments, the system further performing operations including determine a respective target embeddings vector corresponding to a weighted average of the attention embeddings vectors, the predicted next user action being determined based on target item embeddings vectors.

In some embodiments, the system further performing operations including determine a plurality of predicted user actions based on the attention embeddings vectors, generate a respective candidate embeddings vector based on the plurality of predicted user actions, determining a respective similarity score between the target embeddings vectors and the candidate embeddings vectors based on applying a SoftMax loss function, and apply the respective similarity score to the respective target embeddings vector, the predicted next user action being determined based on the respective similarity score between the target embeddings vectors and the candidate embeddings vectors.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure. Some portions of the detailed descriptions of this disclosure have been presented in terms of procedures, logic blocks, processing, and other symbolic representations of operations on data bits within a computer or digital system memory.

These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A method for predicting a next user action at an electronic user interface, the method comprising:
receiving a sequence of user actions for a user;
generating a respective embeddings vector representative of each of the user actions;
determining respective pairwise similarities among the embeddings vectors;
generating a respective attention embeddings vector for each of the user actions according to the similarities;
applying a predictive model to the attention embeddings vectors to determine a predicted next user action; and
outputting the predicted next user action to the user in response to receiving the sequence.

2. The method of claim 1, wherein receiving the sequence of user actions further comprises:
receiving a first sequence of user actions based on a first parameter; and
receiving a second sequence of user actions based on a second parameter.

3. The method of claim 2, wherein generating the respective embeddings vector representative of each of the user actions comprises:
generating a first embeddings vector index based on the first sequence of user actions; and
generating a second embeddings vector index based on the second sequence of user actions;
wherein the respective pairwise similarities are determined based on respective embeddings vectors from the first embeddings vector index and the second embeddings vector index.

4. The method of claim 3, the method further comprising:
applying a causal mask to the respective embeddings vector for each of the user actions; and
concatenating the respective embeddings vectors to determine the respective pairwise similarities among the embeddings vectors.

5. The method of claim 4, wherein concatenating the respective embeddings vectors to determine the respective pairwise similarities among the embeddings vectors comprising:
applying the first embeddings vector index as keys and values, and
applying the second embeddings vector index as queries,
wherein the attention embeddings vectors are generated based on the first embeddings vector index and the second embeddings vector index.

6. The method of claim 2, the method further comprising:
determining a respective target embeddings vector corresponding to a weighted average of the attention embeddings vectors;
wherein the predicted next user action is determined based on target item embeddings vectors.

7. The method of claim 6, the method further comprising:
determining a plurality of predicted user actions based on the attention embeddings vectors;
generating a respective candidate embeddings vector based on the plurality of predicted user actions; and
determining a respective similarity between the candidate embeddings vectors and the target embeddings vectors;
wherein the predicted next user action is determined based on the similarities between the target embeddings vectors and the candidate embeddings vectors.

8. The method of claim 7, wherein determining the respective similarity between the candidate embeddings vectors and the target embeddings vectors comprising:
determining a respective similarity score between the target embeddings vectors and the candidate embeddings vectors based on applying a SoftMax loss function; and
applying the respective similarity score to the respective target embeddings vector.

9. The method of claim 8, wherein the predicted next user action is determined based on the respective similarity score between the target embeddings vectors and the candidate embeddings vectors.

10. The method of claim 1, wherein the embeddings vectors are representative of metadata generated based on the user actions.

11. A system comprising:
a processor; and
a non-transitory computer readable media having stored therein instructions that are executable by the processor to perform operations comprising:
receive a first sequence of user actions based on a first parameter;
receive a second sequence of user actions based on a second parameter;
generate a respective embeddings vector representative of each of the user actions for the first sequence of user actions and the second sequence of user actions;
determine respective pairwise similarities among the embeddings vectors;
generate a respective attention embeddings vector for each of the user actions according to the similarities;
apply a predictive model to the attention embeddings vectors to determine a predicted next user action; and
output the predicted next user action to the user in response to receiving the sequence.

12. The system of claim 11, wherein generating the respective embeddings vector representative of each of the user actions comprises:
generate a first embeddings vector index based on the first sequence of user actions; and
generate a second embeddings vector index based on the second sequence of user actions;
wherein the respective pairwise similarities are determined based on respective embeddings vectors from the first embeddings vector index and the second embeddings vector index.

13. The system of claim 12, the processor further performing operations comprising:
apply a causal mask to the respective embeddings vector for each of the user actions;
apply the first embeddings vector index as keys and values;
apply the second embeddings vector index as queries; and
concatenate the first embeddings vector index and the second embeddings vector index to determine the respective pairwise similarities among the embeddings vectors;
wherein the attention embeddings vectors are generated based on the first embeddings vector index and the second embeddings vector index.

14. The system of claim 12, the processor further performing operations comprising:
determine a respective target embeddings vector corresponding to a weighted average of the attention embeddings vectors;
wherein the predicted next user action is determined based on target item embeddings vectors.

15. The system of claim 14, the processor further performing operations comprising:
determine a plurality of predicted user actions based on the attention embeddings vectors;
generate a respective candidate embeddings vector based on the plurality of predicted user actions;
determine a respective similarity score between the target embeddings vectors and the candidate embeddings vectors based on applying a SoftMax loss function; and
apply the respective similarity score to the respective target embeddings vector;
wherein the predicted next user action is determined based on the respective similarity score between the target embeddings vectors and the candidate embeddings vectors.

16. The system of claim 11, wherein the embeddings vectors are representative of metadata generated based on the first sequence of user actions and the second sequence of user actions.

17. A non-transitory computer readable media having stored therein instructions that are executable by a system to enable the system to perform operations comprising:
receive a first sequence of user actions based on a first parameter;
generate a respective embeddings vector for a first embeddings vector index based on the first sequence of user actions;
receive a second sequence of user actions based on a second parameter;
generate a respective embeddings vector for a second embeddings vector index based on the second sequence of user actions;
determine respective pairwise similarities among the embeddings vectors, wherein the embeddings vectors are representative of metadata generated based on the user actions;
generate a respective attention embeddings vector for each of the user actions according to the similarities;
apply a predictive model to the attention embeddings vectors to determine a predicted next user action; and
output the predicted next user action to the user in response to receiving the sequence;
wherein the respective pairwise similarities are determined based on respective embeddings vectors from the first embeddings vector index and the second embeddings vector index.

18. The non-transitory computer readable media of claim 17, the system further performing operations comprising:
apply a causal mask to the respective embeddings vector for each of the user actions;
apply the first embeddings vector index as keys and values;
apply the second embeddings vector index as queries; and
concatenate the first embeddings vector index and the second embeddings vector index to determine the respective pairwise similarities among the embeddings vectors;
wherein the attention embeddings vectors are generated based on the first embeddings vector index and the second embeddings vector index.

19. The non-transitory computer readable media of claim 17, the system further performing operations comprising:
determine a respective target embeddings vector corresponding to a weighted average of the attention embeddings vectors;
wherein the predicted next user action is determined based on target item embeddings vectors.

20. The non-transitory computer readable media of claim 19, the system further performing operations comprising:
determine a plurality of predicted user actions based on the attention embeddings vectors;
generate a respective candidate embeddings vector based on the plurality of predicted user actions;
determining a respective similarity score between the target embeddings vectors and the candidate embeddings vectors based on applying a SoftMax loss function; and
apply the respective similarity score to the respective target embeddings vector;
wherein the predicted next user action is determined based on the respective similarity score between the target embeddings vectors and the candidate embeddings vectors.
